(19) United States
(12) Patent Application Publication
(10) Pub. No.: US 2026/0024232 A1
(43) Pub. Date: Jan. 22, 2026

(54) Neural Network In-Loop Filter for Machine Tasks

(71) Applicant: TENCENT AMERICA LLC, Palo Alto, CA (US)

(72) Inventors: Roman CHERNYAK, Moscow (RU); Shan LIU, Palo Alto, CA (US); Motong XU, Palo Alto, CA (US)

(73) Assignee: TENCENT AMERICA LLC, Palo Alto, CA (US)

(21) Appl. No.: 19/270,807

(22) Filed: Jul. 16, 2025

Related U.S. Application Data
(60) Provisional application No. 63/673,717, filed on Jul. 20, 2024.
(60) Provisional application No. 63/678,512, filed on Aug. 1, 2024.
(60) Provisional application No. 63/679,042, filed on Aug. 2, 2024.

(51) Int. Cl. G06T 9/00; H04N 19/117; H04N 19/70

(52) U.S. Cl. CPC G06T 9/002; H04N 19/117; H04N 19/70

(57) ABSTRACT

This disclosure relates generally to video coding, and more particularly to in-loop filtering for video coding for machine tasks based on neural networks. For example, utilization of one or more neural network in-loop filter (NNLF) may be determined (either enabled or disabled) at various coding levels. Such determination may be based on output of one or more other VCM-codec-related processed. The usages of the NNLF may be signaled in the bitstream or may be implicitly derived from the output of the one or more other VCM-coded-related processes during decoding process in a decoder or during in-loop decoding process of an encoder. The signaling may be provided at a corresponding constructed syntax structure at one the various coding levels. The NNLF may be applied at various orders with one or more other in-loop or post filters.

This application is based on and claims the benefit of priority to U.S. Provisional Patent Application No. 63/673,717 filed on Jul. 20, 2024, and entitled “NEURAL NETWORK IN-LOOP FILTER FOR MACHINE TASKS,” U.S. Provisional Patent Application No. 63/678,512, filed on Aug. 1, 2024, and entitled “Signaling Methods of Neural Network In-loop Filters,” and U.S. Provisional Patent Application No. 63/679,042 filed on Aug. 2, 2024, and entitled “Decoding Methods for Neural Network In-loop Filters,” which are herein incorporated by reference in their entireties.

### TECHNICAL FIELD

This disclosure relates generally to video coding, and particularly to in-loop filtering for video coding for machine tasks based on neural networks.

### BACKGROUND

Video or images may be consumed by human users for a variety of purposes, for example entertainment, education, etc. Thus, video coding or image coding may often utilize characteristics of human visual systems for better compression efficiency while maintaining good subjective quality.

With the rise of machine learning applications, along with the abundance of sensors, many intelligent platforms have utilized video for machine vision tasks such as object detection, video/image segmentation or object tracking. As a result, encoding video or images for consumption by machine tasks has become an interesting and challenging problem. This has led to the introduction of Video Coding for Machines (VCM) studies.

While the various embodiments below are described in the context of VCM, the underlying principles are generally applicable to other video coding systems.

### SUMMARY

This disclosure relates generally to video coding, and more particularly to in-loop filtering for video coding for machine tasks based on neural networks. For example, utilization of one or more neural network in-loop filter (NNLF) may be determined (either enabled or disabled) at various coding levels. Such determination may be based on output of one or more other VCM-codec-related processed. The usages of the NNLF may be signaled in the bitstream or may be implicitly derived from the output of the one or more other VCM-coded-related processes during decoding process in a decoder or during in-loop decoding process of an encoder. The signaling may be provided at a corresponding constructed syntax structure at one the various coding levels. The NNLF may be applied at various orders with one or more other in-loop or post filters.

In some example implementations, a method for decoding a video is disclosed. The method may include receiving a bitstream of a portion of the video; decoding the bitstream to obtain a reconstructed portion of the video; when it is determined that a neural network in-loop or post filter (NNLF) is to be applied to the reconstructed portion of the video, identifying the NNLF and extracting from the bitstream a set of filter parameters associated with the NNLF; determining an order of applying the NNLF and one or more other in-loop or post filters; and applying the NNLF with the set of filter parameters and the one or more other in-loop or post filters to the reconstructed portion of the video to generate a filtered video portion according to the order.

In the example implementations above, the NNLF is determined as always being applied to an entirety of the video.

In any one of the example implementations above, the method may further include extracting an indication information item from the bitstream to determine whether the NNLF is to be applied to the reconstructed portion of the video.

In any one of the example implementations above, the indication information item is included as a signaling syntax in a Sequence Parameter Set (SPS), a Picture Parameter Set (PPS), a Sequence Header (SH), a Picture Header (PH), or Supplemental Enhancement Information (SEI) in the bitstream.

In any one of the example implementations above, the signaling syntax comprises an NNLF flag included in an SPS to indicate whether the NNLF is applied at a sequence level, and wherein the SPS further indicates an NNLF model parameter set when the NNLF flag indicates that the NNLF is applied at the sequence level.

In any one of the example implementations above, the signaling syntax comprises an NNLF flag included in a VCM extension definition within an SPS to indicate whether the NNLF is applied at a sequence level, and wherein the VCM extension definition further indicates an NNLF model parameter set when the NNLF flag indicates that the NNLF is applied at the sequence level.

In any one of the example implementations above, the signaling syntax comprises an NNLF flag included in a slice header to indicate whether the NNLF is applied at a slice level, and wherein the slice header further indicates an NNLF model parameter set when the NNLF flag indicates that the NNLF is applied at the slice level.

In any one of the example implementations above, the signaling syntax comprises an NNLF mode included in a slice header to indicate whether and how the NNLF is applied at a slice level, and wherein the slice header further indicates an NNLF model parameter set when the NNLF mode indicates that the NNLF is applied at the slice level.

In any one of the example implementations above, the signaling syntax comprises an NNLF flag to indicate whether the NNLF is applied at a slice level and an additional NNLF mode to indicate how the NNLF is applied when the NNLF flag indicate that the NNLF is applied at the slice level, and wherein the slice header further indicates an NNLF model parameter set when the NNLF flag indicates that the NNLF is applied at the slice level.

In any one of the example implementations above, the signaling syntax is provided at a block level of the video.

In any one of the example implementations above, the signaling syntax is provided for each block at a beginning of a slice of the video.

In any one of the example implementations above, the indication information item is extracted based on content of the reconstructed portion of the video.

In any one of the example implementations above, the one or more other in-loop or post filters comprises at least one of a Sample Adaptive Offset (SAO) filter, Cross-Component SAO (CCSAO) filter, Adaptive Loop Filter (ALF), Cross-Component ALF (CCALF), a bilateral-based filter, or a padding process comprising a repetitive padding, a mirror padding, a motion compensated padding, or template-matching-based padding.

In any one of the example implementations above, the NNLF filter is applied to immediately follow the SAO or the CCSAO filter.

In any one of the example implementations above, the NNLF filter is applied to immediately follow the AFL or CCALF.

In any one of the example implementations above, the NNLF is applied to immediately follow the repetitive padding, mirror padding, motion compensated padding, or template-matching-based padding.

In some other implementations, a method for encoding a video is disclosed. The method may include encoding a portion of the video to generate an encoded portion of the video and including the encoded portion of the video in the bitstream; reconstructing the encoded portion of the video to obtain a reconstructed portion of the video; determining whether to apply a neural network in-loop or post filter (NNLF) to the reconstructed portion of the video; determining a set of filter parameters associated with the NNLF and an order of applying the NNLF and one or more other in-loop or post filters when it is determined to apply the NNLF to the reconstructed portion of the video; applying the NNLF with the set of filter parameters and the one or more other in-loop or post filters to the reconstructed portion of the video to generate a filtered video portion according to the order; and using the filtered video portion to encode another portion of the video.

In the example implementations above, the method my further include signaling whether to apply the NNLF and the set of filter parameters when NNLF is applied in: an SPS at a sequence level; a VCM extension of an SPS at a sequence level; a slice header at a slice level; or beginning of a slice at for each block.

In some other example implementations, a non-transitory computer-readable storage medium storing a bitstream of a video is disclosed. The bitstream may be generated by a video encoding method. The video encoding method may include encoding a portion of the video to generate an encoded portion of the video and including the encoded portion of the video in the bitstream; reconstructing the encoded portion of the video to obtain a reconstructed portion of the video; determining whether to apply a neural network in-loop or post filter (NNLF) to the reconstructed portion of the video; determining a set of filter parameters associated with the NNLF and an order of applying the NNLF and one or more other in-loop or post filters when it is determined to apply the NNLF to the reconstructed portion of the video; applying the NNLF with the set of filter parameters and the one or more other in-loop or post filters to the reconstructed portion of the video to generate a filtered video portion according to the order; using the filtered video portion to encode another portion of the video; and signaling a flag indicating whether to apply the NNLF to the portion of the video and the set of filter parameters in the video bitstream.

In the example implementations above, the flag and the set of NNLF parameters when NNLF is applied is signaled in: an SPS at a sequence level; a VCM extension of an SPS at a sequence level; a slice header at a slice level; or beginning of a slice at for each block.

Aspects of the disclosure also provide an electronic device or apparatus function as encoder or decoder including a circuitry configured to carry out any of the method implementations above.

Aspects of the disclosure also provide non-transitory computer-readable medium for storing computer instructions which when executed by at least one processor of a video processing device, cause the video processing device to perform any one of the method implementations above.

### BRIEF DESCRIPTION OF THE DRAWINGS

Further features, the nature, and various advantages of the disclosed subject matter will be more apparent from the following detailed description and the accompanying drawings in which:

FIG. 1 is a diagram of an environment in which methods, apparatuses, and systems described herein may be implemented, according to embodiments.

FIG. 2 is a schematic illustration of an example computer system in accordance with an embodiment.

FIG. 3 is a block diagram of an example architecture for performing video coding, according to embodiments.

FIG. 4 illustrates various decoding modules that may be utilized in a VCM decoder.

FIG. 5 illustrates an example process for deblocking filtering or post filtering in video coding utilizing NNLF.

FIG. 6 shows an example neural network architecture for an NNLF.

### DETAILED DESCRIPTION OF EMBODIMENTS

Throughout this specification and claims, terms may have nuanced meanings suggested or implied in contexts beyond an explicitly stated meaning. The phrase “in one embodiment” or “in some embodiments” as used herein does not necessarily refer to the same embodiment and the phrase “in another embodiment” or “in other embodiments” as used herein does not necessarily refer to a different embodiment. Likewise, the phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments/implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

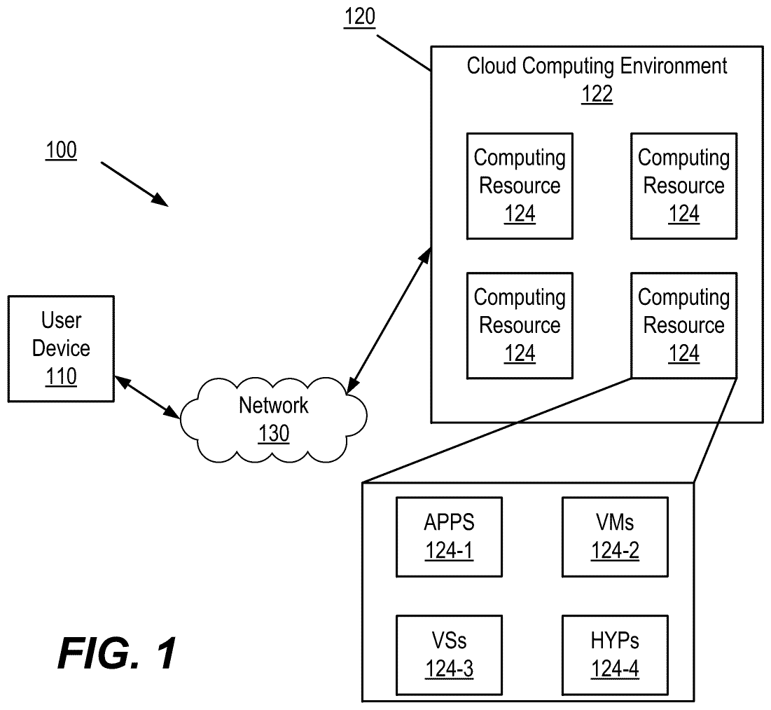

FIG. 1 is a diagram of an application environment 100 in which methods, apparatuses, and systems described herein may be implemented, according to the example embodiments. As shown in FIG. 1, the environment 100 may include a user device 110, a platform 120, and a network 130. Devices of the environment 100 may interconnect via wired connections, wireless connections, or a combination of wired and wireless connections.

The user device 110 may include one or more devices capable of receiving, generating, storing, processing, and/or providing information associated with platform 120. For example, the user device 110 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, the user device 110 may receive information from and/or transmit information to the platform 120.

The platform 120 includes one or more devices as described elsewhere herein. In some implementations, the platform 120 may include a cloud server or a group of cloud servers. In some implementations, the platform 120 may be designed to be modular such that software components may be swapped in or out depending on a particular need. As such, the platform 120 may be easily and/or quickly reconfigured for different uses.

In some implementations, as shown in FIG. 1, the platform 120 may be hosted in a cloud computing environment 122. Notably, while implementations described herein describe the platform 120 as being hosted in the cloud computing environment 122, in some implementations, the platform 120 may not be cloud-based (i.e., may be implemented outside of a cloud computing environment) or may be partially cloud-based.

The cloud computing environment 122 includes an environment that hosts the platform 120. The cloud computing environment 122 may provide computation, software, data access, storage, etc. services that do not require end-user (e.g. the user device 110) knowledge of a physical location and configuration of system(s) and/or device(s) that hosts the platform 120. As shown, the cloud computing environment 122 may include a group of computing resources 124 (referred to collectively as “computing resources 124” and individually as “computing resource 124”).

The computing resource 124 includes one or more personal computers, workstation computers, server devices, or other types of computation and/or communication devices. In some implementations, the computing resource 124 may host the platform 120. The cloud resources may include compute instances executing in the computing resource 124, storage devices provided in the computing resource 124, data transfer devices provided by the computing resource 124, etc. In some implementations, the computing resource 124 may communicate with other computing resources 124 via wired connections, wireless connections, or a combination of wired and wireless connections.

As further shown in FIG. 1, the computing resource 124 includes a group of cloud resources, such as one or more applications (“APPs”) 124-1, one or more virtual machines (“VMs”) 124-2, virtualized storage (“VSs”) 124-3, one or more hypervisors (“HYPs”) 124-4, or the like.

The application 124-1 includes one or more software applications that may be provided to or accessed by the user device 110 and/or the platform 120. The application 124-1 may eliminate a need to install and execute the software applications on the user device 110. For example, the application 124-1 may include software associated with the platform 120 and/or any other software capable of being provided via the cloud computing environment 122. In some implementations, one application 124-1 may send/receive information to/from one or more other applications 124-1, via the virtual machine 124-2.

The virtual machine 124-2 includes a software implementation of a machine (e.g. a computer) that executes programs like a physical machine. The virtual machine 124-2 may be either a system virtual machine or a process virtual machine, depending upon use and degree of correspondence to any real machine by the virtual machine 124-2. A system virtual machine may provide a complete system platform that supports execution of a complete operating system (“OS”). A process virtual machine may execute a single program, and may support a single process. In some implementations, the virtual machine 124-2 may execute on behalf of a user (e.g. the user device 110), and may manage infrastructure of the cloud computing environment 122, such as data management, synchronization, or long-duration data transfers.

The virtualized storage 124-3 includes one or more storage systems and/or one or more devices that use virtualization techniques within the storage systems or devices of the computing resource 124. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

The hypervisor 124-4 may provide hardware virtualization techniques that allow multiple operating systems (e.g. “guest operating systems”) to execute concurrently on a host computer, such as the computing resource 124. The hypervisor 124-4 may present a virtual operating platform to the guest operating systems, and may manage the execution of the guest operating systems. Multiple instances of a variety of operating systems may share virtualized hardware resources.

The network 130 includes one or more wired and/or wireless networks. For example, the network 130 may include a cellular network (e.g. a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g. the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g. one or more devices) of the environment 100 may perform one or more functions described as being performed by another set of devices of the environment 100.

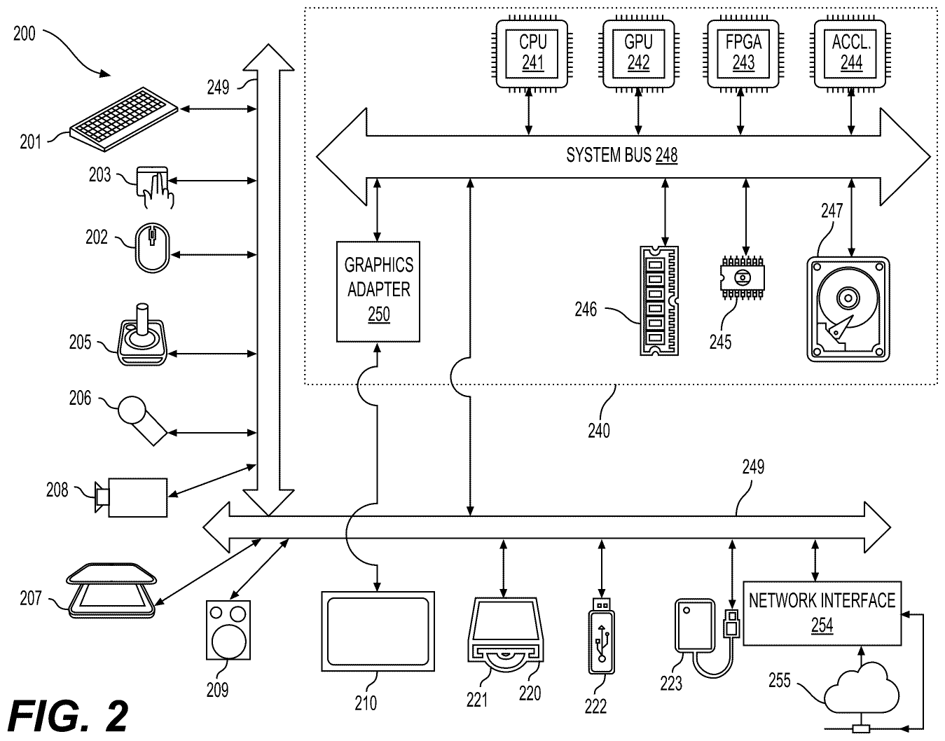

The techniques and implementations described below can be implemented as computer software using computer-readable instructions and physically stored in one or more computer-readable media. For example, FIG. 2 shows a computer system (200) suitable for implementing certain embodiments of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 2 for computer system (200) are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system (200).

Computer system (200) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (201), mouse (202), trackpad (203), touch screen (210), data-glove (not shown), joystick (205), microphone (206), scanner (207), camera (208).

Computer system (200) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (210), data-glove (not shown), or joystick (205), but there can also be tactile feedback devices that do not serve as input devices), audio output devices (such as: speakers (209), headphones (not depicted)), visual output devices (such as screens (210) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (200) can also include human accessible storage devices and their associated media such as optical media including CD/DVD ROM/RW (220) with CD/DVD or the like media (221), thumb-drive (222), removable hard drive or solid state drive (223), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (200) can also include an interface (254) to one or more communication networks (255). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general-purpose data ports or peripheral buses (249) (such as, for example USB ports of the computer system (200)); others are commonly integrated into the core of the computer system (200) by attachment to a system bus as described below (for example Ethernet interface into a PC computer system or cellular network interface into a smartphone computer system). Using any of these networks, computer system (200) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (240) of the computer system (200).

The core (240) can include one or more Central Processing Units (CPU) (241), Graphics Processing Units (GPU) (242), specialized programmable processing units in the form of Field Programmable Gate Areas (FPGA) (243), hardware accelerators for certain tasks (244), graphics adapters (250), and so forth. These devices, along with Read-only memory (ROM) (245), Random-access memory (246), internal mass storage such as internal non-user accessible hard drives, SSDs, and the like (247), may be connected through a system bus (248). In some computer systems, the system bus (248) can be accessible in the form of one or more physical plugs to enable extensions by additional CPUs, GPU, and the like. The peripheral devices can be attached either directly to the core's system bus (248), or through a peripheral bus (249). In an example, the screen (210) can be connected to the graphics adapter (250). Architectures for a peripheral bus include PCI, USB, and the like.

CPUs (241), GPUs (242), FPGAs (243), and accelerators (244) can execute certain instructions that, in combination, can make up the aforementioned computer code. That computer code can be stored in ROM (245) or RAM (246). Transitional data can also be stored in RAM (246), whereas permanent data can be stored for example, in the internal mass storage (247). Fast storage and retrieve to any of the memory devices can be enabled through the use of cache memory, that can be closely associated with one or more CPU (241), GPU (242), mass storage (247), ROM (245), RAM (246), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (200), and specifically the core (240) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (240) that are of non-transitory nature, such as core-internal mass storage (247) or ROM (245). The software implementing various embodiments of the present disclosure can be stored in such devices and executed by core (240). A computer-readable medium can include one or more memory devices or chips, according to particular needs. The software can cause the core (240) and specifically the processors therein (including CPU, GPU, FPGA, and the like) to execute particular processes or particular parts of particular processes described herein, including defining data structures stored in RAM (246) and modifying such data structures according to the processes defined by the software. In addition, or as an alternative, the computer system can provide functionality as a result of logic hardwired or otherwise embodied in a circuit (for example: accelerator (244)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The number and arrangement of components shown in FIG. 2 are provided as an example. In practice, the device 200 may include additional components, fewer components, different components, or differently arranged components than those shown in FIG. 2. Additionally, or alternatively, a set of components (e.g. one or more components) of the device 200 may perform one or more functions described as being performed by another set of components of the device 200.

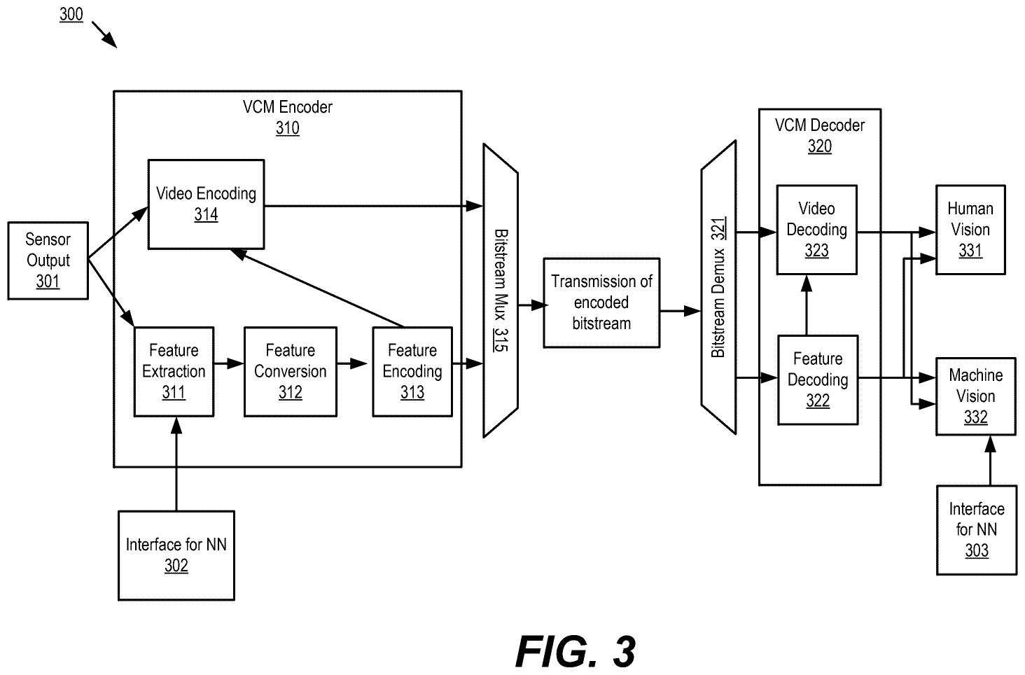

FIG. 3 is a block diagram of an example architecture 300 for performing video coding, according to some example embodiments. In some example implementations, the architecture 300 may be used as a video coding for machines (VCM) architecture, or an architecture that is otherwise compatible with or configured to perform VCM coding. For example, architecture 300 may be compatible with “Use cases and requirements for Video Coding for Machines” (ISO/IEC JTC 1/SC 29/WG 2 N18), “Draft of Evaluation Framework for Video Coding for Machines” (ISO/IEC JTC 1/SC 29/WG 2 N19), and “Call for Evidence for Video Coding for Machines” (ISO/IEC JTC 1/SC 29/WG 2 N20), the disclosures of which are incorporated by reference herein in their entireties.

In some example implementations, one or more of the elements illustrated in FIG. 3 may correspond to, or be implemented by, one or more of the elements discussed above with respect to FIGS. 1-2, for example, one or more of the user device 110, the platform 120, the device 200, or any of the elements included therein.

As can be seen in FIG. 3, the architecture 300 may include a VCM encoder 310 and a VCM decoder 320. In some example embodiments, the VCM encoder may receive sensor output 301 as input to the VCM encoder, which may include for example one or more input images, or an input video. The sensor output 301 may be provided to a feature extraction module 311 which may extract features from the sensor input, and the extracted features may be converted using feature a conversion module 312, and encoded using a feature encoding module 313. In some example implementations, the term “encoding” may include, may correspond to, or may be used interchangeably with, the term “compressing”. The architecture 300 may include an interface 302, which may allow the feature extraction module 311 to interface with a neural network (NN) which may assist in performing the feature extraction.

The sensor output 301 may be provided to a video encoding module 314, which may generate an encoded video. In some example embodiments, after the features are extracted, converted, and encoded, the encoded features may be provided to the video encoding module 314, which may use the encoded features to assist in generating the encoded video. In some example implementations, the video encoding module 314 may output the encoded video as an encoded video bitstream, and the feature encoding module 313 may output the encoded features as an encoded feature bitstream. In some example implementations, the VCM encoder 310 may provide both the encoded video bitstream and the encoded feature bitstream to a bitstream multiplexer 315, which may generate an encoded bitstream by combining the encoded video bitstream and the encoded feature bitstream.

In some example implementations, the encoded bitstream may be received by a bitstream demultiplexer (demux), which may separate the encoded bitstream into the encoded video bitstream and the encoded feature bitstream, which may be provided to the VCM decoder 320. The encoded feature bitstream may be provided to the feature decoding module 322, which may generate decoded features, and the encoded video bitstream may be provided to the video decoding module, which may generate a decoded video. In some example implementations, the decoded features may also be provided to the video decoding module 323, which may use the decoded features to assist in generating the decoded video.

In some example implementations, the output of the video decoding module 323 and the feature decoding module 322 may be used mainly for machine consumption, for example, for use by a machine vision module 332. In some example implementations, the output can also be used for human consumption, as illustrated in FIG. 3 as a human vision module 331. A VCM system, for example, according to the architecture 300, from the client end, for example, from the side of the VCM decoder 320, may perform video decoding to obtain the video in the sample domain first. Then one or more machine tasks to understand the video content may be performed, for example, by the machine vision module 332. In some example implementations, the architecture 300 may include an interface 303, which may allow the machine vision module 332 to interface with an NN which may assist in performing the one or more machine tasks.

As can be seen in FIG. 3, in addition to a video encoding and decoding path, which includes the video encoding module 314 and the video decoding module 323, another path included in the architecture 300 may be a feature extraction, feature encoding, and feature decoding path, which includes the feature extraction module 311, the feature conversion module 312, the feature encoding module 313, and the feature decoding module 322.

Example embodiments below may relate to methods for enhancing decoded video for machine vision, human vision, or human/machine hybrid vision. In some example implementations, each decoded image, which may be generated, for example, by the VCM decoder 320, may be enhanced for machine vision or human vision using an enhancement module and metadata sent from the encoder side. In some example implementations, these methods can be applied to any VCM codec. Although the various example embodiments disclosed herein may be described using broader terms such as “image/video,” or using more specific terms such as “image” and “video”, it may be understood that such embodiments may be applied to other types of data.

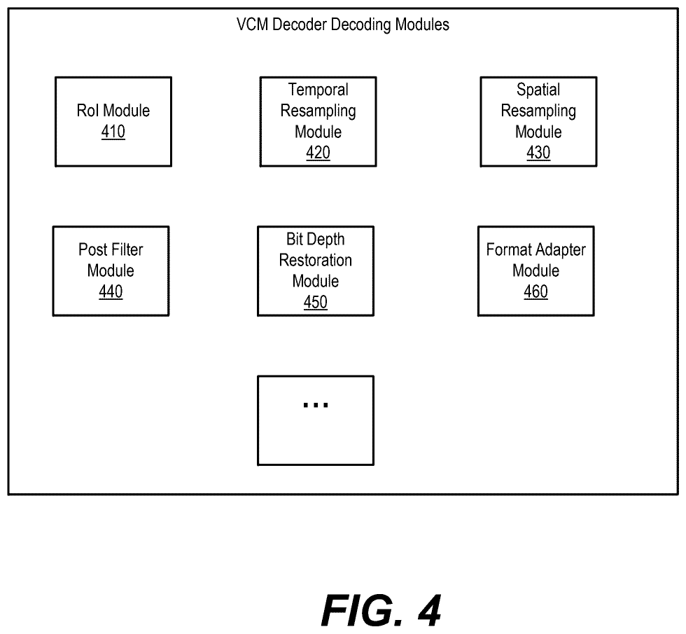

In some example implementations, during and after reconstruction of the input video, various encoding/decoding tools may be utilized to refine or repurpose the video. These tools may be referred to as encoding/decoding modules. From a decoding standpoint, for example, various decoding modules may be executed by a decoder after reconstruction of the image/video to refine or repurpose the image/video. For example, reconstructed image/video may be processed by various decoding module for machine vision in VCM. These tools may be selectively invoked and executed by the decoder. Correspondingly, these tools may be used in the encoder in its encoding process and decoding loop. These modules, in the context of VCM decoder, is shown in FIG. 4. Example decoding modules are shown as Region of Interest (RoI) module 410, temporal resampling module 420 (e.g., temporal upsampling module, temporal interpolation module, temporal extrapolation module, etc.), spatial resampling module 430 (e.g., spatial upsampling module), post filter module 440, bit depth restoration module 450, format adapter module 460, and the like. The post filtering module 440, for example, may include a deblocking filter for removing or reducing artifacts at block boundaries of the reconstructed video. A post filter or deblocking filter may be alternatively referred to as in-loop filters, in that they are also part of an in-loop process after reconstruction in an encoder so that a filtered version of the reconstructed samples of a previous coding unit are used for coding next coding unit. These various modules above may be invoked in certain order during or post reconstruction of the encoded video.

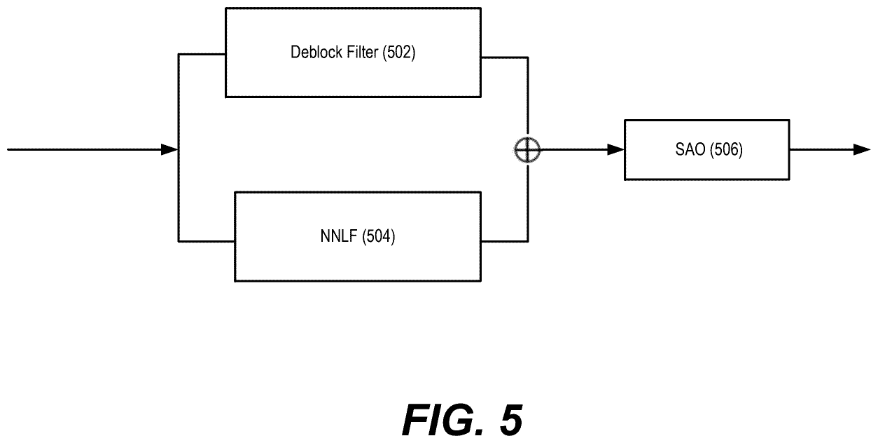

In some example implementations, a neural network-based post filter or neural network based in-loop filter (both referred to as NNLF, or collectively referred to as in-loop filter) may be used for in-loop deblocking/post filtering. Such NNLF may be used by itself. Alternatively, such NNLF may be used in conjunction with or in addition to other deblocking/post filters to process the reconstructed samples. An example is shown in FIG. 5, where both an NNLF 504 and a non-NN deblocking filters 502 are applied to reconstructed samples of the video and the filtered results are combined (e.g., averaged, weight averaged, or in other manners). Merely as an example, the combined results after filtering by the NNLF 504 and non-NN deblocking filters 502 may be further processed by other in-loop or post filters, such as the Sample Adaptive Offset (SAO) filter 506 shown in FIG. 5. Further examples of using NNLF together with other in-loop or post filters are described below.

An NNLF, for example, may include a neural network with model parameters (e.g., weights, bias, and other model parameters). The NNLF may also be characterized by a set of hyper parameters that define the neural network architecture (neural network layer structures and connectivity between the neural network layers). The model parameters and/or the set of hyper parameters may be referred to as an NNLF model parameter set. The NNLF may be pretrained. There may be multiple pretrained NNLF candidates for an encoder and a decoder to use. The choice of which NNLF from the candidate NNLFs to use, if the encoder determines to use an NNLF, may be made by the encoder at various levels (e.g., sequence, subsequence, picture, slice, frame levels), and the choice may be provided to the decoder in the encoded bitstream as an index of chosen NNLF among the candidate NNLFs. The NNLF models, may be stored in or pre-fetched to the encoder and decoder. Alternatively, they may be stored in a repository (local or remote) for the encoder and the decoder to fetch when needed. In some other implementations, the trained model parameters may be provided from the encoder to the decoder, for example, as part of supplemental enhanced information (SEI) of the bitstream. In some example implementations, in the case that the NNLF is to be fetched from or be run at a remote location, a link to the NNLF may be included in the bitstream by the encoder.

An NNLF may also be associated with filter parameters in addition to the neural network model parameters discussed above. As discussed above, these additional parameters may be predefined or may otherwise been made known to both the encoder and the decoder. Alternatively, such filter parameters may be transmitted from the encoder to the decoder in the bitstream in syntax element(s) or in the SEI of the bitstream.

In some other example implementations, usage flag and/or filter parameters may be predefined rather than being signaled.

In some example implementations, the usage of the NNLF to refine reconstructed samples may always be enabled. An NNLF may be applied to every block of every frame of the reconstructed video to preform post filtering in the in-loop processes in the encoder. The decoder, after reconstructing each block, would also apply the NNLF to refine the reconstructed samples. If the encoder has made a choice of an applicable NNLF (e.g., for improving filtering quality) among a plurality of NNLFs at a particular coding unit level (e.g., sequence, subsequence, picture, slice, frame, and the like), the NNLF chosen for the particular coding unit may be signaled in the bit stream. Further, the filtering parameters, if unknow to the decoder, may also be signaled in the bitstream.

In some other example implementations, whether NNLF is to be used may be expressly indicated by one or more syntax elements as included by the encoder in the bitstream. The decoder, correspondingly, may reconstruct the encoded sample, and apply the NNLF appropriately according to the one or more syntax elements in the bitstream. The filter parameters of the NNLF needed in order to apply the post filtering of the reconstructed samples and as determined by the encoder, may also be signaled in the bitstream. The signaling of whether the NNLF usage is enabled may be provided at any signaling levels, including but not limited to the sequence, subsequence, picture, slice, frame levels, and the like. As such, the signaling of whether to enable NNLF may be included in on or more of Sequence Parameter Set (SPS), Picture Parameter Set (PPS), Slice Header (SH), Picture Header (PH), or SEI, or the like.

In some other example implementations, the usage of NNLF at various levels may be implicit in the bitstream. For example, whether the reconstructed samples of a particular unit at a particular coding level are to be processed by an NNLF may be controlled by output(s) of one or more other VCM codec related processing tools. Such VCM codec related processing tools, for example, my include but are not limited to modules for Region of Interest (RoI) processing, bit depth truncation processing, spatial sampling processing, temporal sampling processing, and the like).

Merely as an example, a VCM codec related processing tool that may be relied on for determining the usage of NNLF may include an RoI processing module. In one particular example, whether the NNLF usage may be enabled may be determined, implicitly and without any additional express signaling, on a sequence (or sub-sequence) level. Also as a mere example, one or more output and an RoI processing module may be used to determine whether NNLF should be applied.

For example, the decoder may determine to use or enable an NNLF in a sequence or subsequence of video frames when an RoI space of each frame within the sequence (or sub sequence) is more than some predefined or signaled RoI space threshold. The decoder may determine to not use or disable the NNLF in an entirety of a sequence or subsequence of video frames when the RoI space of any frame within the sequence (or sub sequence) is less than the predefined or signaled RoI space threshold. If the decoder determines that the NNLF is enabled for a particular coding unit, it would then go to the encoded bitstream to further extract one or more filtering parameters for performing the NNLF. The encoder side may use a similar decision process in terms of calculating the RoI space and determining whether to use the NNLF based on the calculated RoI space in its in-loop filtering process.

For another example, the decoder may determine to use or enable an NNLF in a sequence or subsequence of video frames when an RoI space of a majority of the frames within the sequence (or sub sequence) is more than some predefined or signaled RoI space threshold. The term “majority” means more than half, or half or more than half. Likewise, the decoder may determine not to use or disable the NNLF usage in an entirety of a sequence or subsequence of video frames in post filtering of reconstructed samples when the RoI space of a majority of frames within the sequence (or sub sequence) is less than the predefined or signaled RoI space. If the decoder determines that the NNLF is enabled for a particular coding unit, it would then go to the encoded bitstream to further extract one or more filtering parameters for performing the NNLF. The encoder side may use a similar decision process in terms of calculating the RoI space and determine whether to use the NNLF based on the calculated RoI space in its in-loop process.

For yet another example, the decoder may determine to use or enable an NNLF in a sequence or subsequence of video frames when an RoI space of some or any of the frames within the sequence (or sub sequence) is more than some predefined or signaled RoI space threshold. Likewise, the decoder may determine not to use or disable the NNLF in the sequence of subsequence of the video frames when the RoI space of none of the frames within the sequence (or subsequence) is greater than the predefined or signaled RoI space threshold If the decoder determines that the NNLF is enabled for a particular coding unit, it would then go to the encoded bitstream to further extract one or more filtering parameters for performing the NNLF. The encoder side may use a similar decision process in terms of calculating the RoI space and determining whether to use the NNLF based on the calculated RoI space in its in-loop process.

In some other example implementations, whether to apply an NNLF may be determined on a sequence or subsequence level by the encoder and such decision may be explicitly signaled in the bitstream as, for example, a control flag in a Sequence Parameter Set (SPS). For example, the flag may be set at “1” for enabling the NNLF and “0” for disabling the NNLF. Also as a mere example, one or more output and an RoI process may be used to determine whether NNLF should be applied.

For example, the encoder may determine to use or enable an NNLF in a sequence or subsequence of video frames when an RoI space of each frame within the sequence (or sub sequence) is more than some predefined or signaled RoI space threshold. The encoder may determine to not use or disable the NNLF usage in an entirety of a sequence or subsequence of video frames in its in-loop process when the RoI space of any frame within the sequence (or sub sequence) is less than the predefined or signaled RoI space. The encoder may explicitly signal the decision at the sequence level in the bitstream. The decoder may determine whether to apply the NNLF according the explicit signaling. If the decoder determines that the NNLF is enabled for a particular coding unit from the signaling in the bitstream, it would then go to the encoded bitstream to further extract one or more filtering parameters for performing the NNLF.

For another example, the encoder may determine to use or enable an NNLF in a sequence or subsequence of video frames when an RoI space of a majority of frames within the sequence (or sub sequence) is more than some predefined or signaled RoI space threshold. The term “majority” means more than half, or half or more than half. Likewise, the encoder may determine not to use or disable the NNLF usage in an entirety of a sequence or subsequence of video frames in post filtering of reconstructed samples when the RoI space of a majority of frames within the sequence (or sub sequence) is less than the predefined or configured RoI space. The encoder may explicitly signal the decision at the sequence level in the bitstream. The decoder may determine whether to apply the NNLF according the explicit signaling. If the decoder determines that the NNLF is enabled for a particular coding unit from the signaling in the bitstream, it would then go to the encoded bitstream to further extract one or more filtering parameters for performing the NNLF.

For yet another example, the encoder may determine to use or enable an NNLF in a sequence or subsequence of video frames when an RoI space of some or any of the frames within the sequence (or sub sequence) is more than some predefined or signaled RoI space threshold. Likewise, the encoder may determine not to use or disable the NNLF in the sequence of subsequence of the video frames when the RoI space of none of the frames within the sequence (or subsequence) is greater than the predefined or signaled RoI space threshold. The encoder may explicitly signal the decision at the sequence level in the bitstream. If the decoder determines that the NNLF is enabled for a particular coding unit from the signaling in the bitstream, it would then go to the encoded bitstream to further extract one or more filtering parameters for performing the NNLF.

In some example implementations, the usage and/or parameter(s) of NNLF may be predefined without signaling, so that the encoder and the decoder may follow the predefinition to perform or not to perform the NNLF, and if NNLF is to be performed, the encoder and the decoder may use the predefined filter parameters.

In some example implementations, the usage of the NNLF may following the decision at the encoder and the decoder based on the example implementations above and a usage flag for NNLF may not need to be signaled. If the NNLF is to be used based on such decision, the encoder may signal the filter parameters in the bitstream, or alternatively, the filter parameters may be predefined and thus may also not need to be signaled.

In some example implementations, an NNLF flag may still be signaled to indicate that NNLF is allowed. Then if the encoder determines that the NNLF may be used, the NNLF may be applied at appropriate level. Whether the NNLF is actually used/applied within/below that level may be based on the determination process described above. The actual usage may not need to be signaled. The actually used/applied NNLF filters may be signaled or may be predefined.

In some example implementations, the signaling of the usage flag and/or filter parameters for NNLF, if provided, may be set at various levels, e.g., controlled by syntax elements such as SPS (Sequence Parameter Set) PPS (Picture Parameter Set), PH (Picture Header), SH (Sequence Header), and the like.

In some example implementations, the usage flag and parameters of NNLF may be signaled in SPS to indicate NNLF usage at sequence or subsequence level, and provided as, for example, part of a VCM extension. An example is shown in the Table 1 and Table 2 or Table 3 below.

TABLE 1

| | Descriptor |
|---|---|
| seq_parameter_set_rbsp( ) { | |
| ... | |
| sps_extension_flag | u(1) |
| if( sps_extension_flag ) { | |
| sps_range_extension_flag | u(1) |
| sps_vcm_extension_flag | |
| sps_extension_6bits | u(7) |
| if( sps_range_extension_flag ) | |
| sps_range_extension( ) | |
| if( sps_vcm_extension_flag ) | |
| sps_vcm_extension( ) | |
| } | |
| if( sps_extension_6bits ) | |
| while( more_rbsp_data( ) ) | |
| sps_extension_data_flag | u(1) |
| rbsp_trailing_bits( ) | |
| } | |

TABLE 2

| | |
|---|---|
| sps_vcm_extention { | |
| sps_nnlf_enabled_flag | u(1) |
| if ( sps_nnlf_enabled_flag ) { | |
| sps_nnlf_set | ue(v) |
| sps_nnlf_unified_infer_size_base | ue(v) |
| } | |
| } | |

TABLE 3

| | |
|---|---|
| sps_vcm_extention { | |
| sps_nnlf_enabled_flag | u(1) |
| if ( sps_nnlf_enabled_flag ) { | |
| sps_nnlf_set | ue(v) |
| sps_nnlf_unified_infer_size_base | ue(v) |
| sps_nnlf_unified_inf_size_ext | ue(v) |
| sps_nnlf_unified_max_num_prms | ue(v) |
| sps_nnlf_hop_temporal_filtering_enabled_flag | u(1) |
| } | |
| } | |

Where:

sps_nnlf_enabled_flag being equals to 1 specifies that NNLF is enabled for the CLVS, whereas sps_nnlf_enabled_flag being equals to 0 specifies that NNLF is disabled for the CLVS.

sps_nnlf_unified_infer_size_base specifies the base block inference size for the NNLF processing.

sps_nnlf_unified_inf_size_ext specifies the base extension or padding size for the NNLF processing.

sps_nnlf_unified_max_num_prms specifies the number of parameters for the NNLF processing.

The variable NumParams may be derived as follows: NumParams=sps_nnlf_unified_max_num_prms.

sps_nnlf_hop_temporal_filtering_enabled_flag being equals to 1 specifies that temporal HOP filter is enabled for the CLVS, whereas sps_nnlf_enabled_flag being equals to 0 specifies that temporal HOP filter is disabled for the CLVS.

sps_nnlf_set specifies the NNLF set index.

In the example above, the sequence of sub sequence NNFL enablement/usage flag may be provided via the sequence parameter set->VCM extension->sps_nnlf_enabled_flag. The NNLF parameters may follow if the flag is set as enabled, as indicated above. The usage flag and parameters of NNLF are signaled in sps_vcm_extension( ), where sps_vcm_extension( ) is called when sps_vcm_extension_flag equals 1. Alternatively, the NNLF parameter may be predefined and thus not signaled.

In some alternative example implementations, the neural network based in-loop filter usage may be determined and directly signaled on sequence (or sub sequence) level under SPS as shows in the Table 4 or Table 5 below.

TABLE 4

| | Descriptor |
|---|---|
| seq_parameter_set_rbsp( ) { | |
| ... | |
| sps_nnlf_enabled_flag | ue(v) |
| if ( sps_nnlf_enabled_flag ) { | |
| sps_nnlf_set | ue(v) |
| sps_nnlf_unified_infer_size_base | ue(v) |
| } | |
| ... | |
| rbsp_trailing_bits( ) | |
| } | |

TABLE 5

| | Descriptor |
|---|---|
| seq_parameter_set_rbsp ( ){ | |
| ... | |
| sps_nnlf_enabled_flag | u(1) |
| if ( sps_nnlf_enabled_flag ) { | |
| sps_nnlf_unified_infer_size_base | ue(v) |
| sps_nnlf_unified_inf_size_ext | ue(v) |
| sps_nnlf_unified_max_num_prms | ue(v) |
| sps_nnlf_hop_temporal_filtering_enabled_flag | u(1) |
| } | |
| } | |

In the example above, the sequence (or sub sequence) level NNLF flag is included directly under the sequence parameter set. The NNLF parameters follow if the flag is set.

In some example implementations, NNLF setting (e.g., versions of the NNLF models) used for the current picture may be signaled and controlled in SPS (such as the set index sps_nnlf_set above). In some example implementations, all or some of the parameters are signaled when sps_nnlf_set equal to a predefined set index. For example, an NNLF syntax sps_nnlf_set0_prm is signaled only when sps_nnlf_set equal to 0, as shown in Table 6.

TABLE 6

| | Descriptor |
|---|---|
| sps_vcm_extention( ){ | |
| sps_nnlf_enabled_flag | u(1) |
| if ( sps_nnlf_enabled_flag ) { | |
| sps_nnlf_set | ue(v) |
| sps_nnlf_unified_infer_size_base | ue(v) |
| sps_nnlf_unified_inf_size_ext | ue(v) |
| sps_nnlf_unified_max_num_prms | ue(v) |
| sps_nnlf_hop_temporal_filtering_enabled_flag | u(1) |
| if(sps_nnlf_set==0){ | |
| sps_nnlf_set0_prm | |
| } | |
| } | |
| } | |

Wherein sps_nnlf_set0_prm specifies the NNLF parameter(s) used only when sps_nnlf_set equal to 0.

In some other example implementations, whether to apply an NNLF may be determined on a frame or slice level by the decoder according to, for example, output of the RoI processing without any explicit signaling from the bitstream.

For example, the decoder may determine to use or enable an NNLF in a frame or slice of a video when an RoI space of the frame or the slice is more than some predefined or signaled RoI space threshold. The decoder may determine to not use or disable the NNLF usage in the frame or slice when the RoI space of the frame or slide is less than the predefined or signaled RoI space threshold. If the decoder determines that the NNLF is enabled/used for the frame or slice, it would then go to the encoded bitstream to further extract one or more filtering parameters for performing the NNLF. The encoder side may use a similar decision process in terms of calculating the RoI space and determine whether to use the NNLF based on the calculated RoI space in its in-loop process.

In some other example implementations, whether to apply an NNLF may be determined for a frame or slice by the encoder and such decision may be explicitly signaled in the bitstream as, for example, a control flag in a Picture Header (PH) or Slice Header (SH). For example, the flag may be set at “1” for enabling the NNLF and “0” for disabling the NNLF. Also as a mere example, one or more output and an RoI process may be used to determine whether NNLF should be applied.

For example, the encoder may determine to use or enable an NNLF in a frame or slice of a video when an RoI space of the frame or slice is more than some predefined or signaled RoI space threshold. The encoder may determine to not use or disable the NNLF usage in the frame or slice in its in-loop process when the RoI space of the frame or slide is less than the predefined or signaled RoI space. The encoder may explicitly signal the decision at the frame or slice level in the bitstream. The decoder may determine whether to apply the NNLF according the explicit signaling. If the decoder determines that the NNLF is enabled for a particular frame or slice from the signaling in the bitstream, it would then go to the encoded bitstream to further extract one or more filtering parameters for performing the NNLF.

For example, the neural network based in-loop filter usage may be determined on frame/slice level and controlled by a frame/slice level flag such as Picture Header (PH) or Slice Header (SH) control flag, and like, as shown in Table 7 or Table 8 below.

TABLE 7

| | Descriptor |
|---|---|
| slice_header( ) { | |
| ... | |
| if (sps_nnlf_enabled_flag) { | |
| slice_nnlf_used_flag | ue(1) |
| if (slice_nnlf_used_flag ) { | |
| slice_nnlf_unified_mode | ue(v) |
| if (slice_nnlf_unified_mode != 0) { | |
| slice_nnlf_unified_scale_flag | u(1) |
| if (slice_nnlf_unified_scale_flag ) { | |
| if (slice_nnlf_mode − 1 < NumParams) { | |
| y_nn_scale | |
| cb_nn_scale | |
| cr_nn_scale | |
| } else { | |
| for (i = 0; i < NumParams; ++i) { | |
| y_nn_scale[i] | |
| cb_nn_scale[i] | |
| cr_nn_scale[i] | |
| } | |
| } | |
| } | |
| if (slice_nnlf_mode − 1 < NumParams) { | |
| y_roa_flag | u(1) |
| if ( y_roa_flag !=0 ) { | |
| y_roa_offset | u(1) |
| } | |
| cb_roa_flag | u(1) |
| if ( cb_roa_flag !=0 ) { | |
| cb_roa_offset | u(1) |
| } | |
| cr_roa_flag | u(1) |
| if ( cr_roa_flag !=0 ) { | |
| cr_roa_offset | u(1) |
| } | |
| } else { | |
| for (i = 0; i < NumParams; ++i) { | |
| y_roa_flag[i] | u(1) |
| if ( y_roa_flag[i] !=0 ) { | |
| y_roa_offset[i] | u(1) |
| } | |
| cb_roa_flag[i] | u(1) |
| if ( cb_roa_flag[i] !=0 ) { | |
| cb_roa_offset[i] | u(1) |
| } | |
| cr_roa_flag[i] | u(1) |
| if ( cr_roa_flag[i] !=0 ) { | |
| cr_roa_offset[i] | u(1) |
| } | |
| } | |
| } | |
| } | |
| byte_alignment( ) | |
| } | |

TABLE 8

| | Descriptor |
|---|---|
| slice_header( ) { | |
| ... | |
| if (sps_nnlf_enabled_flag) { | |
| slice_nnlf_unified_mode | ue(v) |
| if (slice_nnlf_unified_mode != 0) { | |
| slice_nnlf_unified_scale_mode | ue(v) |
| if (slice_nnlf_unified_scale_mode == 1 ) { | |
| if (slice_nnlf_unified_mode − 1 < NumParams) { | |
| y_nn_scale | ue(v) |
| cb_nn_scale | ue(v) |
| cr_nn_scale | ue(v) |
| } else { | |
| for (i = 0; i < NumParams; ++i) { | |
| y_nn_scale[i] | ue(v) |
| cb_nn_scale[i] | ue(v) |
| cr_nn_scale[i] | ue(v) |
| } | |
| } | |
| } | |
| if (slice_nnlf_unified_mode − 1 < NumParams) { | |
| y_roa_flag | u(1) |
| if ( y_roa_flag !=0 ) { | |
| y_roa_offset | u(1) |
| } | |
| cb_roa_flag | u(1) |
| if ( cb_roa_flag !=0 ) { | |
| cb_roa_offset | u(1) |
| } | |
| cr_roa_flag | u(1) |
| if ( cr_roa_flag !=0 ) { | |
| cr_roa_offset | u(1) |
| } | |
| } else { | |
| for (i = 0; i < NumParams; ++i) { | |
| y_roa_flag[i] | u(1) |
| if ( y_roa_flag[i] !=0 ) { | |
| y_roa_offset[i] | u(1) |
| } | |
| cb_roa_flag[i] | u(1) |
| if ( cb_roa_flag[i] !=0 ) { | |
| cb_roa_offset[i] | u(1) |
| } | |
| cr_roa_flag[i] | u(1) |
| if ( cr_roa_flag[i] !=0 ) { | |
| cr_roa_offset[i] | u(1) |
| } | |
| } | |
| } | |
| } | |
| } | |
| ... | |
| } | |

Wherein:

The slice_nnlf_used_flag parameter of Table 7 specifies whether the NNLF is used in the current slice. The slice_nnlf_used_flag may be alternatively referred to as slice_nnlf_enabled_flag. The syntax Slice_nnlf_used_flag above in Table 7 may be replaced with slice_nnlf_enabled_flag.

The slice_nnlf_unified_mode parameter of Table 7 specifies the NNLF mode when NNLF is used in the current slice (e.g, the slice_nnl_used_flag is 1). For example, in Table 7, if slice_nnlf_unified_mode equal to 0, the NNLF is enabled with variable qpOffset equal to 0 for the current slice; Otherwise, if slice_nnlf_unified_mode equal to 1, the NNLF is enabled with variable qpOffset equal to −5, or 5 for the current slice; Otherwise, if slice_nnlf_unified_mode equal to 2, the NNLF is enabled at block level with variable qpOffset equal to either 0, −5 or 5 for the current slice

The slice_nnlf_unified_mode parameter of Table 8 specifies the NNLF mode. For example, in Table 8, if slice_nnlf_unified_mode equal to 0, NNLF is disabled for the current slice; Otherwise, if slice_nnlf_unified_mode equal to 1, the NNLF is enabled with variable qpOffset equal to 0 for the current slice; Otherwise, if slice_nnlf_unified_mode equal to 2, the NNLF is enabled with variable qpOffset equal to −5, or 5 for the current slice; Otherwise, if slice_nnlf_unified_mode equal to 3, the NNLF is enabled at block level with variable qpOffset equal to either 0, −5 or 5 for the current slice.

The combination of slice_nnlf_used_flag (or alternatively slice_nnlf_enabled_flage) and slice_nnlf_unified_mode of Table 7 gives rise to similar function as the slice_nnlf_unified_mode of Table 8.

The slice_nnlf_unified_mode element of either Table 7 or Table 8 may also be simply specified as slice_nnlf_mode that is correspondingly defined. Correspondingly, the slice_nnlf_mode if used in Table 8 would specify whether the slice NNLF is enabled (or used) and the slice NNLF mode, whereas the slice_nnlf_mode, if used in Table 7, would indicate the NNLF mode when slice NNLF is used/enabled.

The slice_nnlf_unified_scale_mode parameter of Table 8 specifies the blending mode used when blending with the deblocking filter results.

The slice_nnlf_unified_scale_flag parameter of Table 7 specifies whether blending is used or not.

The xlice_nnlf_unified_scale_mode and Sclice_nnfl_unified_scale_flag parameters provide similar effect when they are equal to 1 in Table 7 and Table 8.

The y_nn_scale parameter of Tables 7 and 8 specifies the weight used for blending with the deblocking filter results for Y color component.

The cb_nn_scale parameter of Tables 7 and 8 specifies the weight used for blending with the deblocking filter results for Cb color component.

The cr_nn_scale parameter of Tables 7 and 8 specifies the weight used for blending with the deblocking filter results for Cr color component.

The y_roa_flag parameter of Tables 7 and 8 being equal to 1 specifies that the residual offset adjustment is enabled for Y color component. y_roa_flag being equal to 0 specifies that the residual offset adjustment is disabled for Y color component.

The y_roa_offset parameter of Tables 7 and 8 specifies the residual offset adjustment value for Y color component.

The cb_roa_flag parameter of Tables 7 and 8 being equal to 1 specifies that the residual offset adjustment is enabled for Cb color component. cb_roa_flag being equal to 0 specifies that the residual offset adjustment is disabled for Cb color component

The cb_roa_offset parameter of Tables 7 and 8 specifies the residual offset adjustment value for Cb color component.

cr_roa_flag of Tables 7 and 8 being equal to 1 specifies that the residual offset adjustment is enabled for Cr color component. cr_roa_flag being equal to 0 specifies that the residual offset adjustment is disabled for Cr color component.

The cr_roa_offset parameter of Tables 7 and 8 specifies the residual offset adjustment value for Cr color component.

In the example above, NNLF for the slices under a sequency of sub sequence may be enabled on the slice level when the sequence or subsequence is enabled with NNLF. The NNLF parameters specific to the slices may then follow.

In some example implementations, the usage flag and/or parameter(s) of NNLF may be signaled at a block level. For example, the NNLF usage flag and parameters may be signaled for all the blocks at the beginning of a slice, as shown in Table 9.

TABLE 9

| | Descriptor |
|---|---|
| coding_tree_unit( ) { | |
| xCtb = CtbAddrX << CtbLog2SizeY | |
| yCtb = CtbAddrY << CtbLog2SizeY | |
| if(slice_nnlf_unified_mode && CtbAddrX==0 && CtbAddrY==0) { | |
| for (y=0; y< PicWidthInCtbsX; ++y) { | |
| for(x=0; x< PicWidthInCtbsY; ++y) { | |
| for( cIdx = 0; cIdx < ( sps_chroma_format_idc != 0 ? 3 : 1 ); cIdx++ ){ | |
| if(slice_nnlf_unified_mode − 1>= NumParams) { | |
| ctu_use_nnlf[cIdx][x][y] | ae(v) |
| if(NumParams != 1 && ctu_use_nnlf[cIdx][x][y]) { | |
| use_first_param[cIdx][x][y] | ae(v) |
| if(NumParams != 2 && !use_first_param[cIdx][x][y]) { | |
| nnlf_prm_id_minus1[cIdx][x][y] | ae(v) |
| } | |
| } | |
| } | |
| } | |
| } | |
| } | |
| } | |
| ... | |
| } | |

Wherein:

The ctu_use_nnlf[cIdx][x][y] element being equal to 1 specifies that the NNLF is applied to the coding tree block of the color component indicated by cIdx of the coding tree unit at luma location (x,y). The ctu_use_nnlf[cIdx][x][y] element being equal to 0 specifies that the NNLF is not applied to the coding tree block of the color component indicated by cIdx of the coding tree unit at luma location (x,y).

The use_first_param[cIdx][x][y] element specifies the qpOffset value applied to the coding tree block of the color component indicated by cIdx of the coding tree unit at luma location (x,y).

When NumParams does not equal to 1, the use_first_param[cIdx][x][y] element being equal to 0 specifies that qpOffset equal to 0 is applied to the coding tree block of the color component indicated by cIdx of the coding tree unit at luma location (x,y), whereas the use_first_param[cIdx][x][y] element being equal to 1 specifies that the qpOffset equal to either −5 or 5 is applied to the coding tree block of the color component indicated by cIdx of the coding tree unit at luma location (x,y). When NumParams does not equal to 2, the qpOffset value used for NNLF for the coding tree block of the color component indicated by cIdx of the coding tree unit at luma location (x,y) is further derived from nnlf_prm_id_minus1[cIdx][x][y].

The nnlf_prm_id_minus1[cIdx][x][y] element specifies the qpOffset value used for NNLF for the coding tree block of the color component indicated by cIdx of the coding tree unit at luma location (x,y) when NumParams does not equal to 2 and use_first_param[cIdx][x][y] equal to 1.

For another example, the neural network filter is applied for each block of the processed frame. For example, each block being filtered is associated with coding tree block (CTB) or coding tree unit (CTU) of the compression system (codec). The usage flag and parameters of NNLF may be signaled at each block, as indicated in Table 10.

TABLE 10

| | Descriptor |
|---|---|
| coding_tree_unit( ) { | |
| xCtb = CtbAddrX << CtbLog2SizeY | |
| yCtb = CtbAddrY << CtbLog2SizeY | |
| if(slice_nnlf_unified_mode>= NumParams) { | |
| for( cIdx = 0; cIdx < ( sps_chroma_format_idc != 0 ? 3 : 1 ); cIdx++ ){ | |
| ctu_use_nnlf[cIdx][ CtbAddrX ][ CtbAddrY ] | ae(v) |
| if(NumParams != 1 && ctu_use_nnlf != 0) | |
| use_first_param[cIdx] [ CtbAddrX ][ CtbAddrY ] | ae(v) |
| if(NumParams != 2 && !use_first_param) { | |
| nnlf_prm_id_minus1[cIdx][ CtbAddrX ][ CtbAddrY ] | ae(v) |
| } | |
| } | |
| } | |
| } | |
| ... | |
| } | |

Where:

The element ctu_use_nnlf[cIdx][xCtb>>Ctb Log 2Size Y][yCtb>>Ctb Log 2SizeY] being equal to 1 specifies that the NNLF is applied to the coding tree block of the color component indicated by cIdx of the coding tree unit at luma location (xCtb, yCtb), whereas ctu_use_nnlf[cIdx][xCtb>>Ctb Log 2SizeY][yCtb>>Ctb Log 2Size Y] being equal to 0 specifies that the NNLF is not applied to the coding tree block of the color component indicated by cIdx of the coding tree unit at luma location (xCtb, yCtb).

The element ctu_use_nnlf[cIdx][xCtb>>Ctb Log 2SizeY][yCtb>>Ctb Log 2Size Y] being equal to 1 specifies that the NNLF is applied to the coding tree block of the color component indicated by cIdx of the coding tree unit at luma location (xCtb, yCtb), whereas ctu_use_nnlf[cIdx][xCtb>>Ctb Log 2Size Y][yCtb>>Ctb Log 2Size Y] being equal to 0 specifies that the NNLF is not applied to the coding tree block of the color component indicated by cIdx of the coding tree unit at luma location (xCtb, yCtb).

The element use_first_param[cIdx][xCtb>>Ctb Log 2Size Y][yCtb>>Ctb Log 2Size Y] specifies the qpOffset value applied to the coding tree block of the color component indicated by cIdx of the coding tree unit at luma location (xCtb, yCtb).

When NumParams does not equal to 1, use_first_param[cIdx][xCtb>>Ctb Log 2SizeY][yCtb>>Ctb Log 2SizeY] being equal to 0 specifies that qpOffset equal to 0 is applied to the coding tree block of the color component indicated by cIdx of the coding tree unit at luma location (xCtb, yCtb), whereas use_first_param[cIdx][xCtb>>Ctb Log 2SizeY][yCtb>>Ctb Log 2SizeY] being equal to 1 specifies that the qpOffset equal to either −5 or 5 is applied to the coding tree block of the color component indicated by cIdx of the coding tree unit at luma location (xCtb, yCtb). When NumParams does not equal to 2, qpOffset value used for NNLF for the coding tree block of the color component indicated by cIdx of the coding tree unit at luma location (xCtb, yCtb) is further derived from nnlf_prm_id_minus1[cIdx][xCtb>>Ctb Log 2Size Y][yCtb>>Ctb Log 2Size Y].

The element nnlf_prm_id_minus1[cIdx][xCtb>>Ctb Log 2Size Y][yCtb>>Ctb Log 2Size Y] specifies the qpOffset value used for NNLF for the coding tree block of the color component indicated by cIdx of the coding tree unit at luma location (xCtb, yCtb) when NumParams does not equal to 2 and use_first_param[cIdx][xCtb>>Ctb Log 2SizeY][yCtb>>Ctb Log 2Size Y] equal to 1.

In some example implementations, the neural network based in-loop filtering may be performed via the following example processes that may be added to item 2 of clause 8.8.1 of Rec. ITU-T H.266 (04/22)|ISO/IEC 23090-3:2022. For example, when the sequence or subsequence level NNLF flag sps_nnlf_enabled_flag is equal to 1, the following applies:
The neural network filter process as specified in clause 8.8.4.1 is invoked with the reconstructed picture sample array S_{L} and, when sps_chroma_format_idc is not equal to 0, the arrays S_{Cb} and S_{Cr} as inputs, and the modified reconstructed picture sample array S′_{L} and, when sps_chroma_format_idc is not equal to 0, the arrays S′_{Cb} and S′_{Cr} after neural network filter process as outputs.
The array S′_{L} and, when sps_chroma_format_idc is not equal to 0, the arrays S′_{Cb} and S′_{Cr} are assigned to the array S_{L} and, when sps_chroma_format_idc is not equal to 0, the arrays S_{Cb} and S_{Cr} (which represent the decoded picture), respectively.

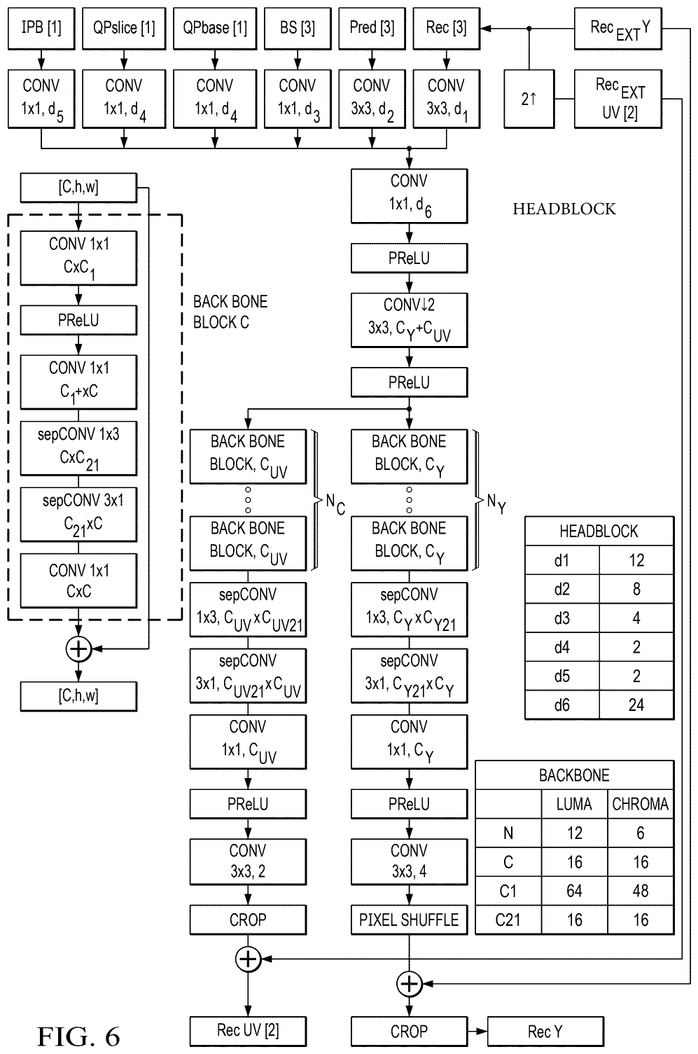

In some example implementations, the neural network based in-loop filtering may be performed via the following example processes, in reference to the example neural network structure of FIG. 6.

```
  Neural network filter process
  General
  Inputs to this process are:
```

| | |
|---|---|
| - | the picture sample array recPicture_{L} for the luma color component, |
| - | the picture sample array recPicture_{Cb} for the Cb color component, |
| - | the picture sample array recPicture_{Cr} for the Cr color component, |
| - | the picture sample array predPicture_{L} for the luma color component, |
| - | the picture sample array predPicture_{Cb} for the Cb color component, |
| - | the picture sample array predPicture_{Cr} for the Cr color component, |
| - | the picture sample array bsPicture_{L} for the luma color component, |
| - | the picture sample array bsPicture_{Cb} for the Cb color component, |
| - | the picture sample array bsPicture_{Cr} for the Cr color component, |
| - | the picture sample array ibpPicture_{L} for the luma color component, |

```
  Outputs of this process are the modified reconstructed picture sample array after the
  neural network filter nnlfPicture_{L} and, when sps_chroma_format_idc is not equal to 0,
  the arrays nnlfPicture_{Cb} and nnlfPicture_{Cr}.
  The input arrays zero padding process is performed for the arrays bsPicture_{L},
  bsPicture_{Cb}, bsPicture_{Cr}, predPicture_{L}, predPicture_{Cb}, predPicture_{Cr} and ibpPicture_{L} as
  specified in the input array zero padding process below.
  This process is performed on a CTU basis in parallel with the deblocking filter process
  for the decoded picture.
  For every CTU with CTB location ( rx, ry ), where rx = 0..PicWidthInCtbsY − 1 and
  ry = 0..PicHeightInCtbsY − 1, the following applies:
```

| | |
|---|---|
| - | The CTU modification process as specified in clause 8.8.4.3 is invoked with |

```
  recPicture_{L}, recPicture_{Cb}, recPicture_{Cr}, predPicture_{L}, predPicture_{Cb}, predPicture_{Cr},
  bsPicture_{L}, bsPicture_{Cb}, bsPicture_{Cr} and ibpPicture_{L} as inputs and a nnlfPicture_{L} and,
  when sps_chroma_format_idc is not equal to 0, arrays nnlfPicture_{Cb} and nnlfPicture_{Cr}
  as outputs.
Input array zero padding process
Inputs to this process are:
```

| | |
|---|---|
| - | the picture sample array arrOrg, |
| - | the width nWidth and height nHeight variables. |

Output of this process is a modified array arrPad.
Two variables nWidthPad and nHeightPad are derived as following:
nWidthPad = nWidth + 16
nHeightPad = nHeight + 16
The picture sample array arrOrg zaerro padding process is performed as following:

| | |
|---|---|
| 1. | for ( i = 0; i < 8 ; ++i) |
| | for ( j = 0; i < nWidthPad ; ++j) |
| | arrPad[i][j] = 0 |
| 2. | for ( i = 8; i < nHeight + 8 ; ++i) |
| | for ( j = 0; i < 8 ; ++j) |
| | arrPad[i][j] = 0 |
| | for ( j = 8; i < nWidth + 8 ; ++j) |
| | arrPad[i][j] = arr[i][j] |
| | for ( j = nWidth + 8; i < nWidthPad; ++j) |
| | arrPad[i][j] = 0 |
| 3. | for ( i = nHeight + 8; i < nHeightPad ; ++i) |
| | for ( j = 0; i < nWidthPad ; ++j) |
| | arrPad[i][j] = 0 |

```
  CTU modification process
  Inputs to this process are:
```

| | |
|---|---|
| - | the picture sample array recPicture_{L} for the luma color component, |
| - | the picture sample array recPicture_{Cb} for the Cb color component, |
| - | the picture sample array recPicture_{Cr} for the Cr color component, |
| - | the picture sample array predPicture_{L} for the luma color component, |
| - | the picture sample array predPicture_{Cb} for the Cb color component, |
| - | the picture sample array predPicture_{Cr} for the Cr color component, |
| - | the picture sample array bsPicture_{L} for the luma color component, |
| - | the picture sample array bsPicture_{Cb} for the Cb color component, |
| - | the picture sample array bsPicture_{Cr} for the Cr color component, |
| - | the picture sample array ibpPicture_{L} for the luma color component, |
| - | a pair of variables ( rx, ry ) specifying the CTB location, |
| - | the CTB width nCtbSw and height nCtbSh. |

Output of this process are

| | |
|---|---|
| - | the modified array nnOutputVector, for the luma color component, |
| - | the modified array nnOutputVectorCb for the Cb color component, |
| - | the modified array nnOutputVectorCr for the Cr color component. |

```
  The location ( xCtb, yCtb ), specifying the top-left sample of the current CTU relative
  to the top-left sample of the current picture component cIdx, is derived as follows:
```

```
  ( xCtb, yCtb ) = ( rx * nCtbSw, ry * nCtbSh )
  ( xSᵢ, ySⱼ ) = ( xCtb + i, yCtb + j )
```

The luma sample locations inside the current CTU are derived as follows:

( xYᵢ, yYⱼ ) = ( xSᵢ, ySⱼ )

The Cb and Cr sample locations inside the current CTU are derived as follows:

( xCᵢ, yCⱼ ) = xSᵢ * SubWidthC, ySⱼ * SubHeightC )

The variable SeqQP is derived as follows:

SeqQP= 26 + pps_init_qp_minus26 + QpOffset.

The variable QpOffset is derived as follows:

QpOffset=(sh_slice_type != I_SLICE ? 5*PrmId*2)*(TemporalId >= 4 ? 1 : −1)

For all sample locations ( xSᵢ, ySⱼ ) and ( xYᵢ, yYⱼ ) with i = 0..nCtbSw − 1 and

j = 0..nCtbSh − 1, the following applies:

```
  -If PrmId[rx][ry] is equal to 0, nnlfPictureL [xSi][ySj] are not modified.
  -Otherwise, the following ordered steps apply:
```

| | |
|---|---|
| 1. | The array nnlfInputVector of 6 elements is constructcted as following: |
| | for ( i = 0; i < nCtbSh; ++i) |
| | for ( j = 0; j < nCtbSw; ++i) |
| | nnlfInputVector[0][i][j][0] = recPicture_{L}[ xYi ][ yYj ] |
| | nnlfInputVector[0][i][j][1] = recPicture_{Cb}[ xCi ][ yCj ] |
| | nnlfInputVector[0][i][j][2] = recPicture_{Cr}[ xCi ][ yCj ] |
| | nnlfInputVector[1][i][j][0] = predPicture_{L} [ xYi ][ yYj ] |
| | nnlfInputVector[1][i][j][1] = predPicture_{Cb} [ xCi ][ yCj ] |
| | nnlfInputVector[1][i][j][2] = predPicture_{Cr} [ xCi ][ yCj ] |
| | nnlfInputVector[2][i][j][0] = bsPicture_{L} [ xYi ][ yYj ] |
| | nnlfInputVector[2][i][j][1] = bsPicture_{Cb} [ xCi ][ yCj ] |
| | nnlfInputVector[2][i][j][2] = bsPicture_{Cr} [ xCi ][ yCj ] |
| | nnlfInputVector[3][i][j] = SliceQpY (or SeqQp) |
| | nnlfInputVector[4][i][j] = QpY (or Slice QpY) |
| | nnlfInputVector[5][i][j] = ibpPicture_{L}[ xYi ][ yYj ] |

```
  The nnlfInputVector array is passed to a neural network and nnOutputVector array is
  obtained as nnOutputVector_{L}, nnOutputVector_{Cb} and nnOutputVector_{Cr}.
```

| | |
|---|---|
| 2. | The modified picture sample array nnOutputVectorL [ xYi ][ xYi ], |
| | nnOutputVectorCb [ xCi ][ xCi ] and nnOutputVectorCr [ xCi ][ xCi ] are derived |
| | as follows |
| | nnOutputVectorL [ xYi ][ xYi ] = Clip3( 0, ( 1 << BitDepth ) − 1, |
| | nnOutputVectorL [ xYi ][ xYi ]) |
| | nnOutputVectorCb [ xCi ][ xCi ] = Clip3( 0, (1 << BitDepth ) − 1, |
| | nnOutputVectorCb [ xCi ][ xCi ]) |
| | nnOutputVectorCr [ xCi ][ xCi ] = Clip3( 0, ( 1 << BitDepth ) − 1, |
| | nnOutputVectorCr [ xCi ][ xCi ]) |
| 3. | nnOutputVectorL [ xYi ][ xYi ], nnOutputVectorCb [ xCi ][ xCi ] and |
| | nnOutputVectorCr [ xCi ][ xCi ] are rounded to output bit depth as |
| | nnOutputVectorL [ xYi ][ xYi ] = Clip3( 0, 1023, (nnOutputVectorL |
| | [ xYi ][ xYi ]+(1<<(Shift−1)))>>Shift) |
| | nnOutputVectorCb [ xCi ][ xCi ] = Clip3( 0, 1023, (nnOutputVectorCb |
| | [ xCi ][ xCi ]+(1<<(Shift−1)))>>Shift) |
| | nnOutputVectorCr [ xCi ][ xCi ] = Clip3( 0, 1023, (nnOutputVectorCr |
| | [ xCi ][ xCi ]+(1<<(Shift−1)))>>Shift) |
| 4. | If slice_nnlf_unified_scale_flag does not equal to 0, the following applies: |
| | -Three parameters Shift, Shift2, and Offset are derived as |
| | Shift = OutputScale−Bitdepth |
| | Shift2 = Shift+ ResidualScale |
| | Offset=(1<<Shift2)/2 |
| | -The nnOutputVectorL [ xYi ][ xYi ], nnOutputVectorCb [ xCi ][ xCi ] and |
| | nnOutputVectorCr [ xCi ][ xCi ] are modified as |
| | if((nnOutputVectorL [ xYi ][ xYi ] − (recPictureL |
| | [ xYi ][ yYj ]<<Shift))>=(ResOffsetAdj[0][rx][ry]<<Shift)) { |
| | nnOutputVectorL [ xYi ][ xYi ] = ((recPictureL [ xYi ][ yYj ]<<Shift2) |
| | + ((nnOutputVectorL [ xYi ][ xYi ]−( recPictureL [ xYi ][ yYj ]<<Shift) |
| | − (ResOffsetAdj[0][rx][ry]<<Shift))*BlendWeight[0][rx][ry] |
| | + Offset)>>Shift2 |
| | } else if((nnOutputVectorL [ xYi ][ xYi ] − (recPictureL |
| | [ xYi ][ yYj ]<<Shift)) <=(−ResOffsetAdj[0][rx][ry]<<Shift)) { |
| | nnOutputVectorL [ xYi ][ xYi ] = ((recPictureL [ xYi ][ yYj ]<<Shift2) |
| | + (nnOutputVectorL [ xYi ][ xYi ]−(r recPictureL [ xYi ][ yYj ]<<Shift) |
| | + (ResOffsetAdj[0][rx][ry]<<Shift))* BlendWeight[0][rx][ry] |
| | + Offset)>>Shift2 |
| | } else { |
| | nnOutputVectorL [ xYi ][ xYi ] = ((recPictureL [ xYi ][ yYj ]<<Shift2) |
| | + (nnOutputVectorL [ xYi ][ xYi ]−( recPictureL [ xYi ][ yYj ]<<Shift)) |
| | * BlendWeight[0][rx][ry] + Offset)>>Shift2 |
| | } |
| | if((nnOutputVectorCb [ xCi ][ xYi ] − (recPictureCb [ xCi ][ yCj ]<<Shift)) |
| | >=(ResOffsetAdj[1][rx][ry]<<Shift)) { |
| | nnOutputVectorCb [ xCi ][ xCi ] = ((recPictureCb |
| | [ xCi ][ yCj ]<<Shift2) |
| | + ((nnOutputVectorCb [ xCi ][ xCi ]−( recPictureCb |
| | [ xCi ][ yCj ]<<Shift) |
| | − (ResOffsetAdj[1][rx][ry]<<Shift))*BlendWeight[1][rx][ry] |
| | + Offset)>>Shift2 |
| | }else if((nnOutputVectorCb [ xCi ][ xCi ] − (recPictureCb |
| | [ xCi ][ yCj ]<<Shift))<=(−ResOffsetAdj[1][rx][ry]<<Shift)) { |
| | nnOutputVectorCb [ xCi ][ xCi ] = ((recPictureCb |
| | [ xCi ][ yCj ]<<Shift2) |
| | + (nnOutputVectorCb [ xCi ][ xCi ]−(r recPictureCb |
| | [ xCi ][ yCj ]<<Shift) |
| | + (ResOffsetAdj[1][rx][ry]<<Shift))* BlendWeight[1][rx][ry] |
| | + Offset)>>Shift2 |
| | } else { |
| | nnOutputVectorCb [ xCi ][ xCi ] = ((recPictureCb |
| | [ xCi ][ yCj ]<<Shift2) |
| | + (nnOutputVectorCb [ xCi ][ xCi ]−( recPictureCb |
| | [ xCi ][ yCj ]<<Shift)) |
| | * BlendWeight[1][rx][ry] + Offset)>>Shift2 |
| | } |
| | if((nnOutputVectorCr [ xCi ][ xYi ] − (recPictureCr [ xCi ][ yCj ]<<Shift)) |
| | >=(ResOffsetAdj[2][rx][ry]<<Shift)) { |
| | nnOutputVectorCr [ xCi ][ xCi ] = ((recPictureCr |
| | [ xCi ][ yCj ]<<Shift2) |
| | + ((nnOutputVectorCr [ xCi ][ xCi ]−( recPictureCr |
| | [ xCi ][ yCj ]<<Shift) |
| | − (ResOffsetAdj[2][rx][ry]<<Shift))*BlendWeight[2][rx][ry] |
| | + Offset)>>Shift2 |
| | } else if((nnOutputVectorCr [ xCi ][ xCi ] − (recPictureCr |
| | [ xCi ][ yCj ]<<Shift))<=(−ResOffsetAdj[2][rx][ry]<<Shift)) { |
| | nnOutputVectorCr [ xCi ][ xCi ] = ((recPictureCr |
| | [ xCi ][ yCj ]<<Shift2) |
| | + (nnOutputVectorCr [ xCi ][ xCi ]−(r recPictureCr |
| | [ xCi ][ yCj ]<<Shift) |
| | + (ResOffsetAdj[2][rx][ry]<<Shift))* BlendWeight[2][rx][ry] |
| | + Offset)>>Shift2 |
| | } else { |
| | nnOutputVectorCr [ xCi ][ xCi ] = ((recPictureCr |
| | [ xCi ][ yCj ]<<Shift2) |
| | + (nnOutputVectorCr [ xCi ][ xCi ]−( recPictureCr |
| | [ xCi ][ yCj ]<<Shift)) |
| | * BlendWeight[2][rx][ry] + Offset)>>Shift2 |
| 5. | Then nnOutputVectorL [ xYi ][ xYi ], nnOutputVectorCb [ xCi ][ xCi ] and |

nnOutputVectorCr [ xCi ][ xCi ] are modified as

```
    nnOutputVectorL [ xYi ][ xYi ] = Clip3(0, (1<< BitDepth)−1,
    nnOutputVectorL [ xYi ][ xYi ])
    nnOutputVectorCb [ xCi ][ xCi ] = Clip3(0, (1<< BitDepth)−1,
    nnOutputVectorL [ xCi ][ xCi ])
    nnOutputVectorCr [ xCi ][ xCi ] = Clip3(0, (1<< BitDepth)−1,
    nnOutputVectorL [ xCi ][ xCi ])
```

In some example implementations, the neural network filter above may be used as either an in-loop filter or a post filter inside the compression systems (codecs). In-loop filters are applied during the encoding and decoding process, specifically after inverse quantization and before storing the reconstructed frame in the decoded picture buffer, impacting subsequent encoding steps and potentially improving compression efficiency. Post-filters, on the other hand, are applied after the entire decoding process is complete, operating on the fully decoded image and providing optional enhancement without affecting the encoder or subsequent frames in the coding loop. A neural network filter either used as in-loop filter or post filter is referred to as NNLF, as described above.

For example, an NNLF may be used in an in-loop filter chain in the codec, in conjunction of other types of in-loop filters. Such an NNLF may be arranged in various configurations with the other in-loop filters.

In some example implementations of using the NNLF as an in-loop filter, the NNLF may be disposed and configured in the codec to process reconstructed signal prior to any other in-loop filtering processing and output of the NNLF may be subsequently processed by the other in-loop filters.

In some example implementations of using the NNLF as an in-loop filter, the NNLF may be disposed and configured in the codec to process the reconstructed signal after processing by at least one deblocking filter.

In some example implementations of using the NNLF as an in-loop filter, the NNLF may be disposed and configured in the codec to process the reconstructed signal processed by at least one sample adaptive offsetting filter such as SAO (Sample Adaptive Offset) filter, CCSAO (Cross-Component SAO), and the like.

In some example implementations of using the NNLF as an in-loop filter, the NNLF may be disposed and configured in the codec to process reconstructed signal processed by at least one Wiener filter such as ALF (Adaptive Loop Filter), CCALF (Cross-Component ALF), and the like.

In some example implementations of using the NNLF as an in-loop filter, the NNLF may be disposed and configured in the codec to process reconstructed signal processed by at least one bilateral-based filter.

In some other example implementations, the neural network filter above may be used as a post filter inside the compression system pipeline.

In some other example implementations, the neural network filter may be configured to use a padding process prior to the main filtering processing. Merely as examples, the padding process can be a repetitive padding, mirror padding, motion compensated padding, template-matching-based padding.

For example, the repetitive padding process may be performed according to the following procedure.

General
Inputs to this process are:
-the picture sample array recPictureL for the luma color component,
-the picture sample array recPictureCb for the Cb color component,
-the picture sample array recPictureCr for the Cr color component,
-the picture sample array predPictureL for the luma color component,
-the picture sample array predPictureCb for the Cb color component,
-the picture sample array predPictureCr for the Cr color component,
-the picture sample array bsPictureL for the luma color component,
-the picture sample array bsPictureCb for the Cb color component,
-the picture sample array bsPictureCr for the Cr color component,
-the picture sample array ibpPictureL for the luma color component,
Outputs of this process are the modified reconstructed picture sample array after the
neural network filter nnlfPictureL and, when sps_chroma_format_idc is not equal to 0,
the arrays nnlfPictureCb and nnlfPictureCr.
The input arrays zero padding process is performed for the arrays bsPictureL,
bsPictureCb, bsPictureCr, predPictureL, predPictureCb, predPictureCr and ibpPictureL
as specified the Input array zero padding process below.
Input array zero padding process:
Inputs to this process are:
-the picture sample array arrOrg,
-the width nWidth and height nHeight variables.
Output of this process is a modified array arrPad.
The picture sample array arrOrg zero padding process is performed as following:
The variable xMargin and yMargin equal to 8 for luma color component and 4 for Cb
and Cr color component.

| | |
|---|---|
| 1. | for(i=0; i<nWidth; ++i) { |
| | for(j=0; j<nHeight; ++j) { |
| | arrPad[i+xMargin][j+yMargin]=arrOrg[i][j]; |
| | } |
| | } |
| 2. | for (i=0; i<xMargin; ++i) { |
| | for(j=0; j< nHeight; ++j) { |
| | arrPad[i][j]=0; |
| | arrPad[i+xMargin+nWidth][j]=0; |
| | } |
| | } |
| 3. | for(i=0; i<nWidth+2*xMargin; ++i) { |
| | for(j=0; j<yMargin; ++j) { |
| | arrPad[i][j+yMargin+nHeight]=0; |
| | } |
| | } |
| 4. | for(i=0; i< nWidth+2*xMargin; ++i) { |
| | for(j=0; j<yMargin; ++j) { |
| | arrPad[i][j]=0; |
| | } |
| | } |

In some example implementations, the neural network filter may use existing codec information as inputs for the neural network of the NNLF. Merely as examples, such existing codec information may include reconstructed samples, and/or predicted samples, and/or blocking (deblocking) information such as boundaries strength map, and/or Quantization Parameter (QP) values, and/or blocks prediction types such as Intra-prediction type, Inter-prediction type, or Inter Block Copy (IBC) type, etc.

An example process for using existing codec information is illustrated below. The array nnlfInputVector of 6 elements is constructed as following:

$$for ( i = 0 ; i < nCtbSh ; ++ i )$$

$$for ( j = 0 ; j < nCtbSw ; ++ i )$$

$$nnlfInputVector [ 0 ] [ i ] [ j ] [ 0 ] = recPictureL [ xYi ] [ yYj ]$$

$$nnlfInputVector [ 0 ] [ i ] [ j ] [ 1 ] = recPictureCb [ xCi ] [ yCj ]$$

$$nnlfInputVector [ 0 ] [ i ] [ j ] [ 2 ] = recPictureCr [ xCi ] [ yCj ]$$

$$nnlfInputVector [ 1 ] [ i ] [ j ] [ 0 ] = predPictureL [ xYi ] [ yYj ]$$

$$nnlfInputVector [ 1 ] [ i ] [ j ] [ 1 ] = predPictureCb [ xCi ] [ yCj ]$$

$$nnlfInputVector [ 1 ] [ i ] [ j ] [ 2 ] = predPictureCr [ xCi ] [ yCj ]$$

$$nnlfInputVector [ 2 ] [ i ] [ j ] [ 0 ] = bsPictureL [ xYi ] [ yYj ]$$

$$nnlfInputVector [ 2 ] [ i ] [ j ] [ 1 ] = bsPictureCb [ xCi ] [ yCj ]$$

$$nnlfInputVector [ 2 ] [ i ] [ j ] [ 2 = bsPictureCr [ xCi ] [ yCj ]$$

$$nnlfInputVector [ 3 ] [ i ] [ j ] = SeqQp$$

$$nnlfInputVector [ 4 ] [ i ] [ j = SliceQpY$$

$$nnlfInputVector [ 5 ] [ i ] [ j ] = ibpPictureL [ xYi ] yYj ]$$

The nnlfInput Vector array is passed to a neural network and nnOutputVector array is obtained as nnOutputVectorL, nnOutputVectorCb and nnOutputVectorCr.

In some example implementations, a neural network structure of the NNLF is based on convolutional layers. Such NNLF convolutional layer structure may be provided as normative or informative specification. An example neural network structure is illustrated FIG. 6.

In some example implementations, such a neural network structure may be a normative part of the decoding process.

In some example implementations, such a neural network structure may be an informative part of the decoding process.

In some example implementations, the processing block for NNLF may be associated with coding block (CB) or coding unit (CU) of the compression system (codec).

In some example implementations, a method for decoding a video is disclosed. The method may include, receiving a bitstream of a portion of the video; decoding the bitstream to obtain a reconstructed portion of the video; when it is determined that a neural network in-loop or post filter (NNLF) is to be applied to the reconstructed portion of the video, identifying the NNLF and extracting from the bitstream a set of filter parameters associated with the NNLF; determining an order of applying the NNLF and one or more other in-loop or post filters; and applying the NNLF with the set of filter parameters and the one or more other in-loop or post filters to the reconstructed portion of the video to generate a filtered video portion according to the order.

In some example implementations, the method for encoding a video is disclosed. The method may include encoding a portion of the video to generate an encoded portion of the video and including the encoded portion of the video in the bitstream; reconstructing the encoded portion of the video to obtain a reconstructed portion of the video; determining whether to apply a neural network in-loop or post filter (NNLF) to the reconstructed portion of the video; determining a set of NNLF parameters and an order of applying the NNLF and one or more other in-loop or post filters when it is determined to apply the NNLF to the reconstructed portion of the video; applying the NNLF with the set of filter parameters and the one or more other in-loop or post filters to the reconstructed portion of the video to generate a filtered video portion according to the set of NNLF parameters and the order; and using the filtered video portion to encode another portion of the video.

In some example implementations, a non-transitory computer-readable storage medium storing a bitstream of a video is disclosed. The bitstream is generated by a video encoding method. The video encoding method may include encoding a portion of the video to generate an encoded portion of the video and including the encoded portion of the video in the bitstream; reconstructing the encoded portion of the video to obtain a reconstructed portion of the video; determining whether to apply a neural network in-loop or post filter (NNLF) to the reconstructed portion of the video; determining a set of NNLF parameters and an order of applying the NNLF and one or more other in-loop or post filters when it is determined to apply the NNLF to the reconstructed portion of the video; applying the NNLF with the set of filter parameters and the one or more other in-loop or post filters to the reconstructed portion of the video to generate a filtered video portion according to the set of NNLF parameters and the order; using the filtered video portion to encode another portion of the video; and signaling a flag indicating whether to apply the NNLF to the portion of the video and the set of NNLF parameters in the video bitstream.

The processes above can be suitably adapted. Step(s) in these processes can be modified and/or omitted. Additional step(s) can be added. Any suitable order of implementation can be used.

The techniques disclosed in the present disclosure may be used separately or combined in any order. Further, each of the techniques (e.g., methods, embodiments), encoder, and decoder may be implemented by processing circuitry (e.g., one or more processors or one or more integrated circuits). In some examples, the one or more processors execute a program that is stored in a non-transitory computer-readable medium.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A method for decoding a video, comprising:
receiving a bitstream of a portion of the video;
decoding the bitstream to obtain a reconstructed portion of the video;
when it is determined that a neural network in-loop or post filter (NNLF) is to be applied to the reconstructed portion of the video, identifying the NNLF and extracting from the bitstream a set of filter parameters associated with the NNLF;
determining an order of applying the NNLF and one or more other in-loop or post filters; and
applying the NNLF with the set of filter parameters and the one or more other in-loop or post filters to the reconstructed portion of the video to generate a filtered video portion according to the order.

2. The method of claim 1, wherein the NNLF is determined as always being applied to an entirety of the video.

3. The method of claim 1, further comprising extracting an indication information item from the bitstream to determine whether the NNLF is to be applied to the reconstructed portion of the video.

4. The method of claim 3, wherein the indication information item is included as a signaling syntax in a Sequence Parameter Set (SPS), a Picture Parameter Set (PPS), a Sequence Header (SH), a Picture Header (PH), or Supplemental Enhancement Information (SEI) in the bitstream.

5. The method of claim 4, wherein the signaling syntax comprises an NNLF flag included in an SPS to indicate whether the NNLF is applied at a sequence level, and wherein the SPS further indicates an NNLF model parameter set when the NNLF flag indicates that the NNLF is applied at the sequence level.

6. The method of claim 4, wherein the signaling syntax comprises an NNLF flag included in a VCM extension definition within an SPS to indicate whether the NNLF is applied at a sequence level, and wherein the VCM extension definition further indicates an NNLF model parameter set when the NNLF flag indicates that the NNLF is applied at the sequence level.

7. The method of claim 3, wherein the signaling syntax comprises an NNLF flag included in a slice header to indicate whether the NNLF is applied at a slice level, and wherein the slice header further indicates an NNLF model parameter set when the NNLF flag indicates that the NNLF is applied at the slice level.

8. The method of claim 4, wherein the signaling syntax comprises an NNLF mode included in a slice header to indicate whether and how the NNLF is applied at a slice level, and wherein the slice header further indicates an NNLF model parameter set when the NNLF mode indicates that the NNLF is applied at the slice level.

9. The method of claim 4, wherein the signaling syntax comprises an NNLF flag to indicate whether the NNLF is applied at a slice level and an additional NNLF mode to indicate how the NNLF is applied when the NNLF flag indicate that the NNLF is applied at the slice level, and wherein the slice header further indicates an NNLF model parameter set when the NNLF flag indicates that the NNLF is applied at the slice level.

10. The method of claim 4, wherein the signaling syntax is provided at a block level of the video.

11. The method of claim 10, wherein the signaling syntax is provided for each block at a beginning of a slice of the video.

12. The method of claim 3, wherein the indication information item is extracted based on content of the reconstructed portion of the video.

13. The method of claim 1, wherein the one or more other in-loop or post filters comprises at least one of a Sample Adaptive Offset (SAO) filter, Cross-Component SAO (CCSAO) filter, Adaptive Loop Filter (ALF), Cross-Component ALF (CCALF), a bilateral-based filter, or a padding process comprising a repetitive padding, a mirror padding, a motion compensated padding, or template-matching-based padding.

14. The method of claim 13, wherein the NNLF filter is applied to immediately follow the SAO or the CCSAO filter.

15. The method of claim 13, wherein the NNLF filter is applied to immediately follow the AFL or CCALF.

16. The method of claim 13, wherein the NNLF is applied to immediately follow the repetitive padding, mirror padding, motion compensated padding, or template-matching-based padding.

17. A method for encoding a video, comprising:
encoding a portion of the video to generate an encoded portion of the video and including the encoded portion of the video in the bitstream;
reconstructing the encoded portion of the video to obtain a reconstructed portion of the video;
determining whether to apply a neural network in-loop or post filter (NNLF) to the reconstructed portion of the video;
determining a set of filter parameters associated with the NNLF and an order of applying the NNLF and one or more other in-loop or post filters when it is determined to apply the NNLF to the reconstructed portion of the video;
applying the NNLF with the set of filter parameters and the one or more other in-loop or post filters to the reconstructed portion of the video to generate a filtered video portion according to the order; and
using the filtered video portion to encode another portion of the video.

18. The method of claim 17, further comprising signaling whether to apply the NNLF and the set of filter parameters when NNLF is applied in:
an SPS at a sequence level;
a VCM extension of an SPS at a sequence level;
a slice header at a slice level; or
beginning of a slice at for each block.

19. A non-transitory computer-readable storage medium storing a bitstream of a video that is generated by a video encoding method, the video encoding method comprising:
encoding a portion of the video to generate an encoded portion of the video and including the encoded portion of the video in the bitstream;
reconstructing the encoded portion of the video to obtain a reconstructed portion of the video;
determining whether to apply a neural network in-loop or post filter (NNLF) to the reconstructed portion of the video;
determining a set of filter parameters associated with the NNLF and an order of applying the NNLF and one or more other in-loop or post filters when it is determined to apply the NNLF to the reconstructed portion of the video;
applying the NNLF with the set of filter parameters and the one or more other in-loop or post filters to the reconstructed portion of the video to generate a filtered video portion according to the order;
using the filtered video portion to encode another portion of the video; and
signaling a flag indicating whether to apply the NNLF to the portion of the video and the set of filter parameters in the video bitstream.

20. The method of claim 19, wherein the flag and the set of filter parameters when NNLF is applied is signaled in:
an SPS at a sequence level;
a VCM extension of an SPS at a sequence level;
a slice header at a slice level; or
beginning of a slice at for each block.
